(19) United States
(12) Patent Application Publication
(10) Pub. No.: US 2012/0304806 A1
(43) Pub. Date: Dec. 6, 2012

(54) PEDAL SYSTEM

(75) Inventor: Constantin Alexandru Dumitrescu, Oakville (CA)

(73) Assignee: BIPEDS LIMITED, Oakville, ON (CA)

(21) Appl. No.: 13/576,678

(22) PCT Filed: Feb. 3, 2011
(86) PCT No.: PCT/CA11/50064

§ 371 Date: Aug. 2, 2012

(30) Foreign Application Priority Data
Feb. 3, 2010 (CA) 2692106

(51) Int. Cl. G05G 1/36

(52) U.S. Cl. 74/561

(57) ABSTRACT

A pedal system containing a right foot pedal, a left foot pedal and a motion inverter mechanism. The right foot pedal is moveable from a right foot pedal neutral position to a depressed acceleration position. The left foot pedal is moveable from a left foot pedal neutral position to a depressed braking position. The motion inverter mechanism operatively couples to the right and left foot pedals, for movement of the right foot pedal or the left foot pedal in an opposite direction to a raised position upon depression of the other of the right foot pedal or the left foot pedal. Also disclosed is a method of preventing concurrent depression of the gas and brake pedal. The pedal system disclosed can allow left foot braking and can also prevent concurrent depression of the gas and brake pedals, and hence, avoid stalling an automobile. The pedal system may also be installed with “drive by wire” type automobiles.

This application claims the benefit of and priority to Canadian Patent Application no. 2,692,106 filed Feb. 3, 2010 under the title VEHICLE PEDAL SYSTEM. The content of the above patent application is hereby expressly incorporated by reference into the detailed description hereof.

### TECHNICAL FIELD

Some example embodiments relate to a pedal system that can be used in an automobile.

### BACKGROUND

Automobiles have at least two pedals for speed modulation: the gas pedal for acceleration and the brake pedal for decelerating and stopping the vehicle. The location of both these pedals in the vehicle allows operation by only the right foot of the driver. Therefore, driver needs to move the right foot from one pedal to the other.

Automobiles equipped with automatic gearboxes also have two pedals for modulating speed: a gas pedal for acceleration and a brake pedal for decelerating and stopping. In such vehicles, the two pedals are located in front of the driver on the right side, so the driver uses only his/her right foot to operate either pedal. The main reason for preserving this historic arrangement from standard vehicles is that this way the driver cannot operate both pedals simultaneously, consequently stalling the engine and losing control of the vehicle.

This typical pedal arrangement has at least the following inconveniences:
Moving the right foot from the gas pedal to the brake pedal requests a time that adds to the braking time, i.e. the time spent from the moment the driver decides to apply the brakes to the moment the vehicle comes to a full stop;
Drivers with right foot/leg mobility problems may take more time to move from one pedal to the other. They may also experience pain in the right foot/leg, which can constitute a distraction from the task of driving;
Professional drivers experience pain in their right knee more often than occasional ones, in a statistically significant manner. This is the result of excessive wear of the knee due to repetitive motion of the leg, required to operate both pedals.

Some drivers try to address these deficiencies by left foot braking. Unfortunately, the location of the brake pedal, being meant for use with the right foot, makes its operation by the left foot rather awkward. In addition to that, reacting inertial loads is more difficult without the left foot firmly supported by the dead pedal. Another issue with left foot braking is the possibility of simultaneously pressing both pedals and consequently stalling the engine and by that losing control of the vehicle. Even drivers who regularly use this mode of operating the vehicle pedals admit that such an event may occur in a moment of panic.

Another attempt at correcting the second deficiency consists in mounting a device over the existent pedals transforming them from right foot pedals to left foot pedals. Such a design is good for drivers who can not use but their left foot for operating the vehicle pedals. Nevertheless, this is still a one-foot solution and in fact transforms all the drawbacks generated by the right-foot-only operation of the pedals into drawbacks created by a left-foot-only operation.

Other difficulties with conventional systems would be appreciated in view of the description below.

### SUMMARY OF THE INVENTION

In one example embodiment, there is provided a pedal system including a right foot pedal moveable from a right foot pedal neutral position to a right foot pedal depressed position, a left foot pedal moveable from a left foot pedal neutral position to a left foot pedal depressed position, and a motion inverter mechanism operatively coupled to the right and left foot pedals, for movement of the right foot pedal or the left foot pedal in an opposite direction to a raised position upon depression of the other of the right foot pedal or the left foot pedal.

In another example embodiment, there is provided a method of preventing concurrent depression of a left foot pedal and a right foot pedal by using a motion inverter mechanism operatively coupled to the right and the left foot pedals. The method comprising the steps of: depressing the right foot pedal from a right foot pedal neutral position to a right foot pedal depressed position, and wherein the motion inverter mechanism is for moving of the left foot pedal in an opposite direction from a left foot pedal neutral position to a left foot pedal raised position upon depression of the right foot pedal.

In yet another example embodiment, there is provided a method for operating a pedal system, comprising moving a right food pedal or a left foot pedal from a neutral position to a depressed position, and moving the other of the right food pedal or the left foot pedal in an opposite direction to a raised position from the neutral position using a motion inverter mechanism operatively coupled between the right and left foot pedals.

### BRIEF DESCRIPTION OF THE FIGURES

FIG. 1 is an isometric view of an example embodiment of the pedal system in accordance with an example embodiment.

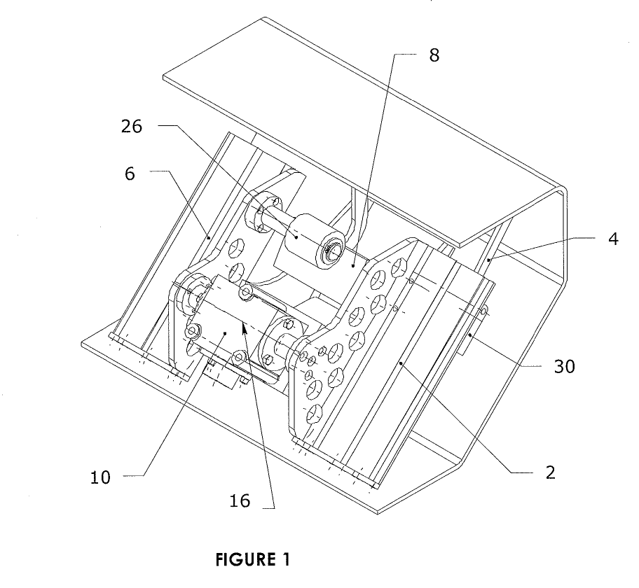

FIG. 2 is a front view of the pedal system of FIG. 1.

FIG. 3 is a sectional view along the line A-A of the pedal system as shown in FIG. 2.

FIG. 4 is a sectional view along the line B-B of the pedal system as shown in FIG. 2.

FIG. 5 is an exploded view of another example embodiment of the pedal system.

FIG. 6 is an isometric view of the pedal system shown in FIG. 5.

FIG. 7 is a front view of the pedal system shown in FIG. 5.

FIG. 8 is a sectional view along the line A-A of the pedal system as shown in FIG. 7.

FIG. 9 is a sectional view along the line B-B of the pedal system as shown in FIG. 8.

FIG. 10 shows an embodiment of a torsion spring for use in an embodiment of the pedal system.

### DETAILED DESCRIPTION

It would be advantageous to provide a pedal system that allows left foot braking, while allowing acceleration using the right foot. In addition, it would be advantageous to provide a pedal system that can mitigate the detrimental impact of the current pedals present in an automobile. Moreover, it would be advantageous to provide a pedal system that allows for left foot braking and may be installed for use on the existing pedals of an automobile.

Example embodiments relate to a pedal system (1), where the driver uses both feet to modulate the speed of the vehicle. Both feet are fully supported by the two pedals of the system (1). As a result, the driver can both modulate vehicle speed and react to inertial forces, which act upon his/her body during the operation of the vehicle, without changing feet location. In one embodiment, the specification discloses a pedal system (1) for use with a two pedal car, to modulate the vehicle speed: accelerate, decelerate and eventually stop the vehicle.

Example embodiments will be further described with reference to the accompanying figures that disclose a pedal system (1) featuring a right foot pedal pedal (2) and a left foot pedal (6) that are mechanically connected through a motion inverter means (10) including a motion inverter mechanism, which facilitates opposing movement of the right and left foot pedals (2, 6) in opposite directions. This pedal system (1) can be mounted over and act upon the existing pedals in the vehicle: the right foot pedal (2) can act upon the gas pedal (4) into an acceleration position and the left foot pedal (6) activates the brake pedal (8) into a braking position. In a neutral position, neither foot pedal (2, 6) is depressed. When the driver depresses one pedal down, the motion inverter means (10) oppositely moves the other pedal up into a raised position with respect to the neutral position. This feature of the design inhibits the driver from pressing both the gas pedal (4) and the brake pedal (8) at the same time, therefore reducing the risks associated with left foot braking, i.e. stalling the engine or wearing down the braking system.

In one embodiment, for example and without limitation, the pedal systems (1) pedals (2, 6) are rotatively coupled and rotate about an axis (16) that falls close to a same axis as the driver's ankles. Therefore, the driver needs only to flex his/her feet from the ankle to operate the pedals (2, 6). This can require much less effort than the current automotive pedals (4, 8), as the effort that is required is shared by both feet and is provided by the ankle muscles, which are amongst the strongest muscles in the human body. This way of operating the pedals can also allow the driver to react to inertial forces, which may occur during driving, through his/her feet without having to change the position of the pedals (2, 6) and therefore maintaining the intended speed of the vehicle.

At all times, the driver may keep both feet firmly planted on the two pedals (2, 6), with no contact with the vehicle floor, modulating the vehicle speed by depressing the right foot pedal (2) to accelerate or, alternatively, depressing the left foot pedal (6) to slow down the vehicle. This is one mode of operation, as driver can maintain control over the vehicle with little effort and significant efficiency. This is similar to keeping both hands on the steering wheel. This mode of operation allows the driver to react to inertial loads. However, if necessity arises, the pedal system (1) may be operated with one foot only, either left or right.

In another embodiment, the pedal system (1) contains a motion inverter means (10) including a motion inverter mechanism, having a right foot pedal coaxial shaft (12) and a left foot pedal coaxial shaft (14) that protrude from the opposite ends of the inverter (10) housing in opposite directions. The motion inverter means (10) facilitates opposing movement between the right and the left foot pedals (2, 6). The motion inverter means (10) can be of any nature (mechanical, hydraulic etc.) and of any design as long as the output shafts (12, 14) are coaxial and rotate in opposite directions. A bracket (18) supports the motion inverter means (10) and thus connects the pedal system (1) to the vehicle structure.

As noted above, the motion inverter means (10) used in accordance with the specification is not particularly limited, and can be, for example and without limitation, a three-bevel-gear motion inverter. The three-bevel-gear motion inverter can be a commercially available product, for example and without limitation, it can be Tandler™ unit having part no. is STD 00 1:1 EA-II, as would be understood in the art. The three-bevel-gear motion inverter can contain, as its name indicates, three bevel or miter gears meshing in sequence 1-2-3. Gears 1 and 3 are mounted on collinear shafts, facing each other and both meshing with gear 2. If gear 1 is the driver, its teeth that engage gear 2 push the latter's teeth in a certain direction. As gear 2 rotates, its diametrically opposed teeth engage gear 3, turning it in the opposite direction. If gear 3 drives in a certain direction, then gear 2 will move gear 1 in the opposite direction. Therefore, gears 1 and 3 can work either way, as driving or driven gears, while gear 2 only transfers and inverts the motion in between them. Additional information about the Tandler™ three-bevel-gear motion inverter can also be found on http://www.tandler.co.uk/.

In another embodiment, for example and without limitation, the motion inverter means can be a hydraulic/pneumatic motion inverter that consists of two rotary actuators, such as vane actuators, installed in-line, butting each other and having their ports connected in such a way as to produce motion in opposite directions. Each pedal is rigidly mounted on the shaft of the associated vane. When one pedal is pressed, it will rotate its vane in a certain direction, sending the power fluid (oil or air) to the other actuator, moving its vane and therefore the other pedal, in the opposite direction because of the cross-connection of the ports.

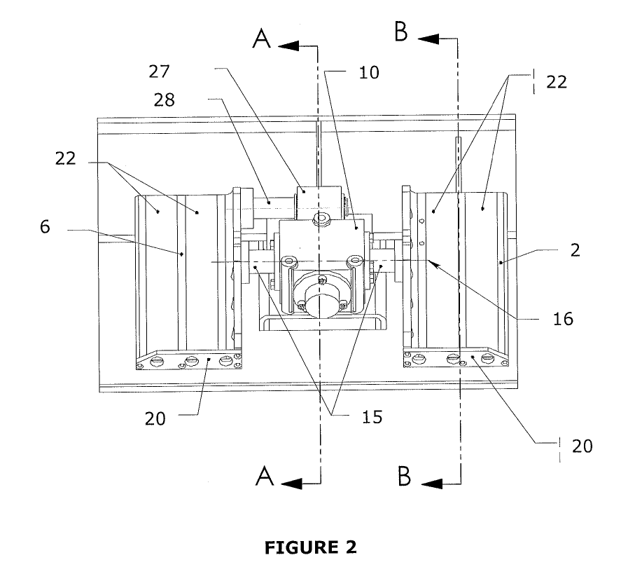

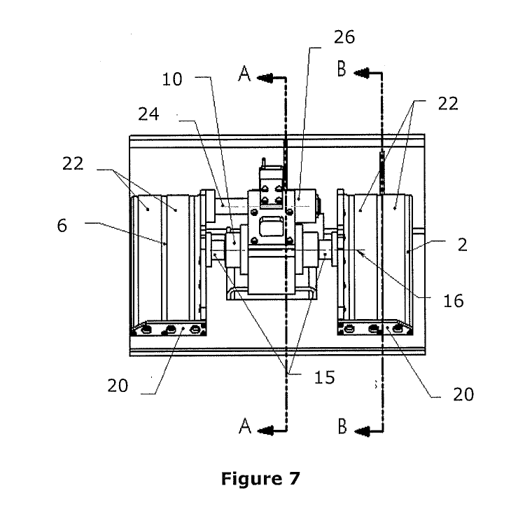

In one embodiment in accordance with the specification, the two pedals (2, 6) of the pedal system (1) can be L-shaped, with one side of the L-shape serving as support for driver's feet and the other connecting the pedals (2, 6) to the motion inverter means (10) through flange connectors (15) installed on the output shafts (12, 14) of the motion inverter means (10), as shown in FIGS. 2 and 7. The centerline of the output shafts (12, 14) can be so located such as to ensure that it is in an approximate height alignment with the driver's ankles, for the reasons discussed above.

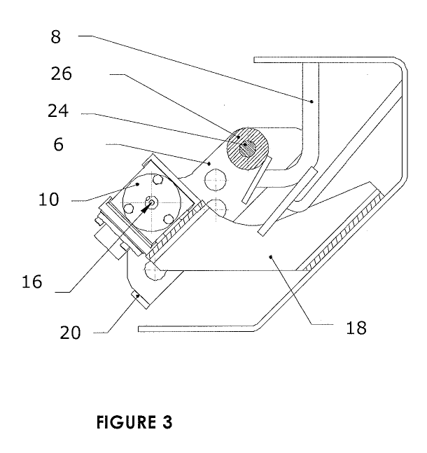

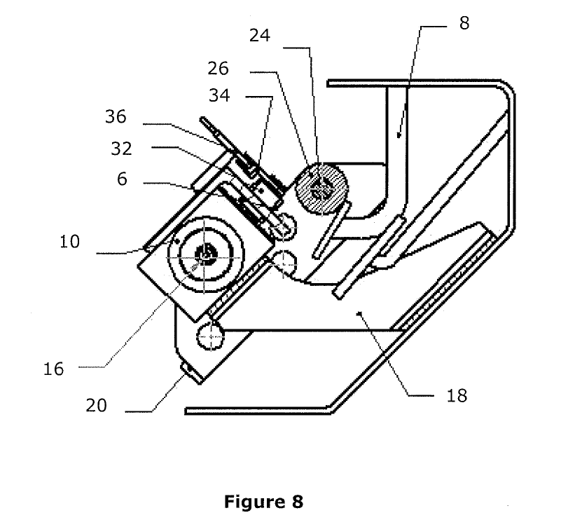

Heel locators (20) can also be provided that can be bolted near the heel end of the pedals (2, 6), as shown in FIGS. 3, 4, 8 and 9, to align the driver's ankles with the motion inverter output shafts (12, 14) along the length of the pedals (2, 6). Pedals (2, 6) can also be padded with friction lining (22), as shown in FIGS. 2 and 7, for better adherence with driver's feet.

In one embodiment in accordance with the specification, the left foot pedal (6) can feature a cantilevered shaft (24), mounted on the side, as shown in FIGS. 2, 3, 7 and 8, on which a left foot roller (26) can rotate. The latter acts upon the vehicle brake pedal (8), when the left foot pedal (6) is pushed down. When that happens, the right foot pedal (2) moves up in the air (raised with respect to the neutral position), losing contact with the vehicle gas pedal (4).

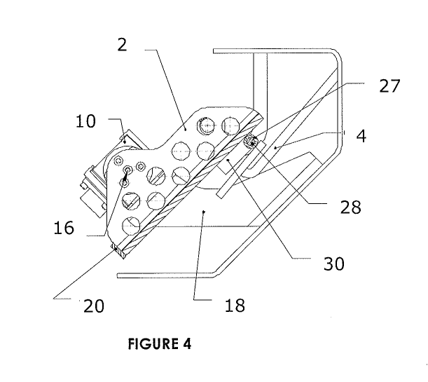

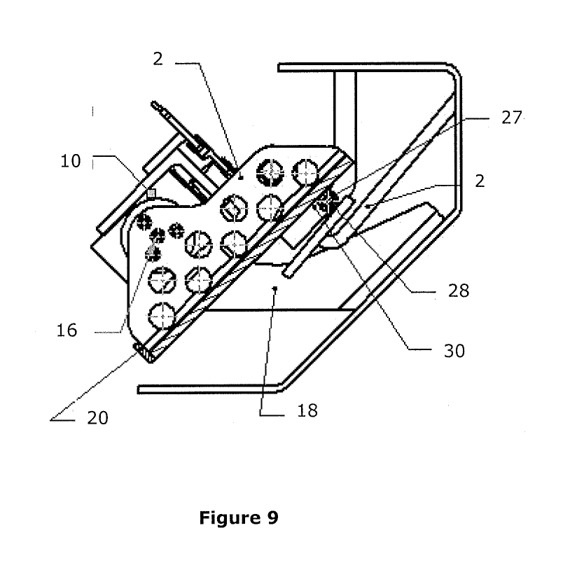

In another embodiment in accordance with the specification, a right foot roller (27) is mounted, on its shaft (28) and support bracket (30), under the right foot pedal (2), as can be seen in FIGS. 4 and 9, and it presses the vehicle gas pedal (4) down, when the right foot pedal (2) goes down. Under these circumstances, the left foot pedal (6) leaves the vehicle brake pedal (8) behind and lifts in the air.

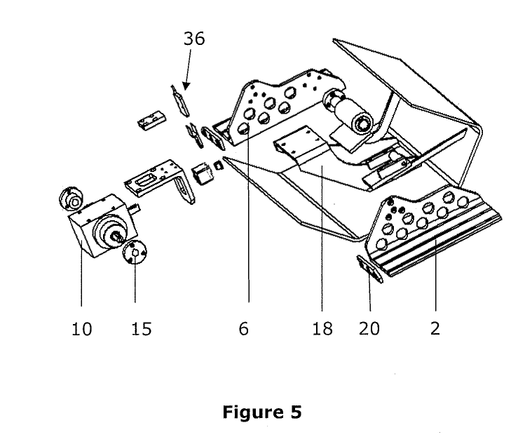

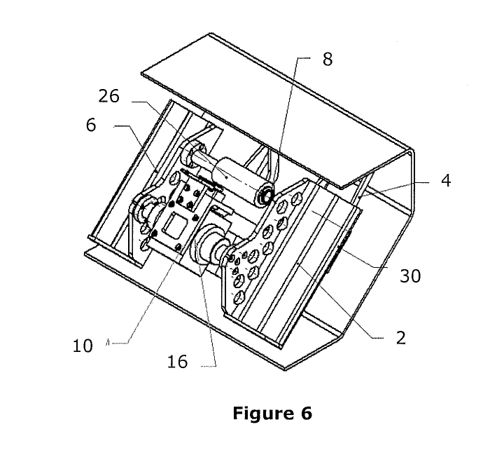

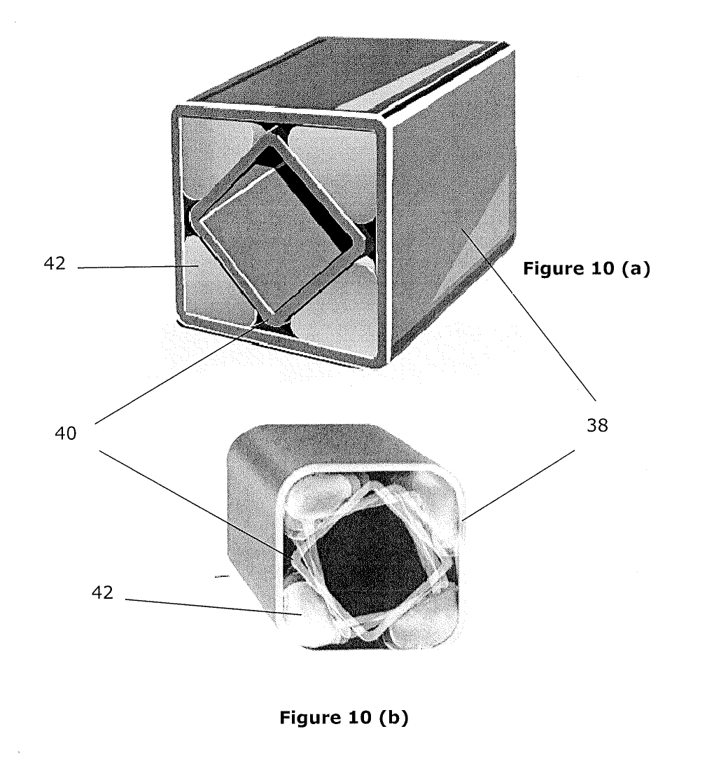

In a further example embodiment, with reference now to FIGS. 5 to 9, the pedal system (1) can be provided with a biasing means (32) biasing the right and left foot pedals (2, 6) towards a neutral position. The biasing means (32) used in accordance with the specification is not particularly limited, and can be for example and without limitation a torsion spring. In one embodiment, for example and without limitation, the biasing means is a bi-directional torsion spring that can be mounted onto the centre shaft of the inverter means (10), thereby circumscribing the centre shaft. Its role is to bring the motion inverter means (10) in the neutral position, when no force is applied to the pedals (2, 6). In a further embodiment in accordance with the specification, a Rosta™ suspension unit can be used (FIG. 10), as would be understood in the art. The Rosta™ suspension unit consists of a steel square bar (38) coaxially mounted inside a steel square tube (40). The two steel parts are rotated by 45° relative to each other. Four (round) rubber rods (42) are compressed into the four spaces created by each external square tube corner with its respective side of the central square bar. When one steel component is held stationary and the other is rotated about their common axis, the four rubber rods are squeezed even further, yielding but opposing the motion, like a spring. When the rotating torque ceases, the four rubber rods release their spring energy and bring the rotated component in its neutral position and the whole assembly in its equilibrium position. Additional information about the Rosta™ suspension unit can also be found on http://www.rostainc.com/pdfs/applications/Rosta_Catalogues/Technology.pdf. Other biasing members are also possible.

In a further example embodiment, referring still to FIGS. 5 to 9, the pedal system (1) further comprises a detector that can sense and can communicate the position or relative position of the right or left foot pedals (2, 6). In one embodiment, for example and without limitation, the detector includes an activator (34) and an angle sensor (36). The angle sensor (36) can be a blade-shaped, solid-state inductive sensor, such as for example, an angle sensor made by Gill Sensors™ as would be understood in the art. The activator (34) can be a U-shaped piece of ferro-magnetic material. The motion of the activator (34) relative to the blade angle sensor (36) modifies the magnetic field of the latter and therefore induces in it an electrical current. Additional information about such sensors and how they can also be found on http://www.gillsensors.co.uk/content/25mmBlade.htm and http://www.gillsensors.co.uk/content/datasheets/25mm.pdf. The electric current induced, is used to measure the angle of motion and hence can be sent to a controller as a signal that is proportional to the angle of motion. As the angle sensor (36) can be programmed to work on a range of +/−30°, the controller must decide whether to accelerate the car, i.e. send the signal to the throttle actuator, or brake it by sending the signal to the actuator connected to the master cylinder of the braking system. Such vehicle systems which can receive the signals may be referred to as “drive by wire” systems, or the like. In some example embodiments, it can be appreciated that this single angle sensor (36) may be used to sense both acceleration and braking, since the right and left foot pedals (2, 6) are known to be opposing.

It can be appreciated that example embodiments of the pedal system (1) may be installed onto existing vehicles, for example, to engage the existing gas and brake pedals. In other example embodiments, the pedal system (1) may be installed at the manufacturing level to act as a replacement to the existing gas and brake pedals. In such embodiments, the detector may send appropriate signals for acceleration and deceleration control of the vehicle, which may be a “drive by wire” vehicle. Example embodiments, without intending to be limiting, may apply to vehicles having two pedals, and related vehicles which may be automatic gearboxes, continuous variable transmission, or double-clutch gearboxes, as would be understood in the art.

It can be appreciated that example embodiments may allow the driver to use both feet for accelerating, modulating speed and braking, wherein both feet are supported by pedals. As a consequence, braking time may be reduced which translates into short stopping distance. Further, less pain and therefore distraction from driving for people with leg/foot mobility problems (e.g. arthritis, foot bursitis etc.). Further, example embodiments may prevent and reduce right knee pain for professional drivers. Example embodiments may assist people having poor eye-foot/leg coordination in avoiding accidents. The elderly may fall in this category, but there are also people who have this unfortunate trait at any age. Example embodiments may allows left foot braking without the risk of depressing both pedals (gas and brake) at the same time, stalling the engine and therefore losing control of the car.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes, modifications and substitutions of equivalents may be made therein without departing from the spirit and scope of this invention which is intended to be unlimited by the foregoing except as may appear in the following appended claims.

Therefore, the embodiments of the invention in which an exclusive property or privilege is claimed are defined in the following appended claims.

1. A pedal system, comprising:
a right foot pedal moveable from a right foot pedal neutral position to a right foot pedal depressed position, wherein the right foot pedal extends to a right heel end for fully supporting a first foot;
a left foot pedal moveable from a left foot pedal neutral position to a left pedal foot depressed position, wherein the left foot pedal extends to a left heel end for fully supporting a second foot; and
a motion inverter mechanism operatively coupled to the right and left foot pedals, for movement of the right foot pedal or the left foot pedal in an opposite direction to a raised position upon depression of the other of the right foot pedal or the left foot pedal.

2. The pedal system according to claim 1, further comprising a biasing means biasing the right and the left foot pedals to their respective neutral positions.

3. The pedal system according to claim 2, wherein the biasing means is coupled to the motion inverter mechanism.

4. The pedal system according to claim 1, further comprising a detector for sensing and communicating position of the right or left foot pedal.

5. The pedal system according to claims 4, wherein the detector is an angle sensor coupled to the motion inverter mechanism.

6. The pedal system according to claim 1, wherein the right and the left foot pedals are rotatively coupled to the motion inverter mechanism.

7. The pedal system according to claim 1, wherein the motion inverter mechanism comprises a right foot pedal output shaft coupled to the right foot pedal and a left foot pedal output shaft coupled to the left foot pedal, and the right and the left foot pedal output shafts being coaxial.

8. The pedal system according to claim 7, wherein each of the right and the left foot pedal output shafts are positioned proximate to each of the right and left heel ends on each of the right and the left foot pedals, and wherein the axis of the coaxial right and left foot pedal output shafts is proximate to and transversely positioned to an ankle of an operator.

9. The pedal system according to claim 1, wherein the right foot pedal comprises a right foot pedal heel locator or the left foot pedal comprises a left foot pedal heel locator.

10. The pedal system according to claim 1, wherein the left foot pedal is coupled to a left foot roller for contacting a brake pedal or the right foot pedal is coupled to a right foot roller for contacting a gas pedal.

11. The pedal system according to claim 1, wherein the right foot pedal comprises a right foot pedal frictional liner or the left foot pedal comprises a left foot pedal frictional liner.

12. A method of preventing concurrent depression of a left foot pedal and a right foot pedal by using a motion inverter mechanism operatively coupled to the right and the left foot pedals, the method comprising the steps of:
depressing the right foot pedal from a right foot pedal neutral position to a right foot pedal depressed position, wherein the right foot pedal extends to a right heel end for fully supporting a first foot and wherein the left foot pedal extends to a left heel end for fully supporting a second foot, and
wherein the motion inverter mechanism Is for moving of the left foot pedal in an opposite direction from a left foot pedal neutral position to a left foot pedal raised position upon depression of the right foot pedal.

13. The method according to claim 12, wherein the pedal system further comprises a biasing means biasing the right and the left foot pedals to their respective neutral positions.

14. The method according to claim 13, wherein the biasing means is coupled to the motion inverter mechanism.

15. The method according to claim 12, wherein the pedal system further comprises a detector for sensing and communicating position of the right or left foot pedal to a throttle or to a braking system.

16. The method according to claim 15, wherein the detector is an angle sensor coupled to the motion inverter mechanism.

17. The method according to claim 12, wherein the right and the left foot pedals are rotatively coupled to the motion inverter mechanism.

18. The method according to claim 12, wherein the motion inverter mechanism comprises a right foot pedal output shaft coupled to the right foot pedal and a left foot pedal output shaft coupled to the left foot pedal, the right and the left foot pedal output shafts being coaxial.

19. The method according to claim 18, wherein each of the right and the left foot pedal output shafts are positioned proximate to each of the right and left heel ends on each of the right and the left foot pedals, and wherein the axis of the coaxial right and left foot pedal output shafts is proximate to and transversely positioned to an ankle of an operator.

20. A method for operating a pedal system, comprising:
moving a right foot pedal or a left foot pedal to a depressed position from a neutral position, wherein the right foot pedal extends to a right heel end for fully supporting a first foot and wherein the left foot pedal extends to a left heel end for fully supporting a second foot; and
moving the other of the right food pedal or the left foot pedal in an opposite direction to a raised position from the neutral position using a motion inverter mechanism operatively coupled between the right and left foot pedals.

21. The method according to claim 20, wherein the motion inverter mechanism comprises a right foot pedal output shaft coupled to the right foot pedal and a left foot pedal output shaft coupled to the left foot pedal, the right and the left foot pedal output shafts being coaxial.

22. The method according to claim 21, wherein each of the right and the left foot pedal output shafts are positioned proximate to each of the right and left heel ends on each of the right and the left foot pedals, and wherein the axis of the coaxial right and left foot pedal output shafts is proximate to and transversely positioned to an ankle of an operator.
